(19) United States
(12) Patent Application Publication
(10) Pub. No.: US 2012/0070363 A1
(43) Pub. Date: Mar. 22, 2012

(54) METHOD FOR PRODUCING AMMONIA

(75) Inventors: Norbert Auner, Glashütten (DE); Banibrata Pandey, Hyderabad (IN)

(73) Assignee: SPAWNT PRIVATE S.a.r.l., Luxembourg (LU)

(21) Appl. No.: 13/254,206

(22) PCT Filed: Feb. 26, 2010
(86) PCT No.: PCT/DE2010/000218

§ 371 Date: Nov. 29, 2011

(30) Foreign Application Priority Data
Mar. 3, 2009 (DE) 10 2009 011 311.8

(51) Int. Cl. C01C 1/04

(52) U.S. Cl. 423/353

(57) ABSTRACT

A method for producing ammonia includes reacting SiO₂ and/or Al₂O₃, or material containing SiO₂ and/or Al₂O₃, with addition of a carbon source, with gaseous nitrogen at elevated temperature to give silicon nitride (Si₃N₄) and/or aluminum nitride (AlN), or material containing silicon nitride and/or aluminum nitride, and reacting resultant silicon nitride and/or aluminum nitride, or material containing silicon nitride and/or aluminum nitride, in the presence of a basic alkali metal compound and/or alkaline earth metal compound, with water at elevated temperature to give ammonia and alkali metal silicates and/or alkaline earth metal silicates.

### RELATED APPLICATIONS

This is a §371 of International Application No. PCT/DE2010/000218, with an international filing date of Feb. 26, 2010 (WO 2010/099780, published Sep. 10, 2010), which is based on German Patent Application No. 10 2009 011 311.8, filed Mar. 3, 2009, the subject matter of which is incorporated by reference.

### TECHNICAL FIELD

This disclosure relates to a method for producing ammonia.

### BACKGROUND

There are a large number of methods for producing ammonia, of which the Haber-Bosch process is the best-known. Also known is the method referred to as the Serpek process, which relates to the hydrolysis of nitrides (2AlN+3H₂O→Al₂O₃+2NH₃). One of the most important nitrides is silicon nitride (Si₃N₄). The preparation of silicon nitride from SiO₂ sources by carbonitriding is known. In carbonitriding, silicon dioxide is reacted at elevated temperature with gaseous nitrogen through addition of a carbon source.

It could therefore be helpful to provide a method for producing ammonia that allows particularly effective utilization of natural resources.

### SUMMARY

We provide a method for producing ammonia including reacting SiO₂ and/or Al₂O₃, or material containing SiO₂ and/or Al₂O₃, with addition of a carbon source, with gaseous nitrogen at elevated temperature to produce silicon nitride (Si₃N₄) and/or aluminum nitride (AlN), or material containing silicon nitride and/or aluminum nitride, and reacting resultant silicon nitride and/or aluminum nitride, or material containing silicon nitride and/or aluminum nitride, in the presence of a basic alkali metal compound and/or alkaline earth metal compound, with water at elevated temperature to produce ammonia and alkali metal silicates and/or alkaline earth metal silicates.

### DETAILED DESCRIPTION

We provide a method for producing ammonia by reacting SiO₂ and/or Al₂O₃, or material containing SiO₂ and/or Al₂O₃, with addition of a carbon source, with gaseous nitrogen at elevated temperature to produce silicon nitride (Si₃N₄) and/or aluminum nitride (AlN), or material containing silicon nitride and/or aluminum nitride, and reacting the resultant silicon nitride and/or aluminum nitride, or material containing silicon nitride and/or aluminum nitride, in the presence of a basic alkali metal compound and/or alkaline earth metal compound, with water at elevated temperature to produce ammonia and alkali metal silicates and/or alkaline earth metal silicates.

The method is a two-stage method in which, in a first stage, silicon nitride and/or aluminum nitride is prepared and, in a second stage, ammonia is prepared from the silicon nitride and/or aluminum nitride. The silicon nitride and/or aluminum nitride, or material containing silicon nitride and/or aluminum nitride, is reacted, in the presence of a basic alkali metal compound and/or alkaline earth metal compound, with water. Due to the fact that not only the substances needed to produce silicon nitride and aluminum nitride (SiO₂ and/or Al₂O₃, or material containing SiO₂ and/or Al₂O₃, carbon source, gaseous nitrogen), but also the substances needed to produce ammonia (basic alkali metal compound and/or alkaline earth metal compound, water) are available as natural, cheap resources, our method can be implemented easily and cost-effectively. Since, moreover, the method does not require elevated pressures, but only elevated temperatures, the method can also be carried out relatively simply and inexpensively from the standpoint of process engineering.

A starting product contemplated for the method is SiO₂ and/or Al₂O₃, or material containing SiO₂ and/or Al₂O₃, more particularly in the form of sand (quartz sand), silicates, aluminosilicates, clay, bauxite and the like. It is not necessary to use pure starting material. Instead, this material may also have corresponding impurities or additions, provided it is SiO₂- and/or Al₂O₃-containing or silicate- and/or aluminate-containing, respectively. There is, therefore, no need for costly and/or inconvenient purification measures.

The typical substances may be used as a carbon source.

A further advantage of the method is that there is no need to prepare pure silicon nitride and/or aluminum nitride. Instead, to produce ammonia, it is sufficient to generate material containing silicon nitride and/or aluminum nitride, and so, as mentioned, there is no need for costly and inconvenient measures for purifying the starting material or materials.

It is essential that the reaction of the resultant silicon nitride and/or aluminum nitride, or material containing silicon nitride and/or aluminum nitride, with water (steam) takes place in the presence of a basic alkali metal compound and/or alkaline earth metal compound. This basic alkali metal compound and/or alkaline earth metal compound may be added to the silicon nitride and/or aluminum nitride, or material containing silicon nitride and/or aluminum nitride, before the addition of water. As a source thereof it is also possible to add a compound of this kind which releases a basic alkali metal compound and/or alkaline earth metal compound at the corresponding process temperature. In each case, the reaction with water must take place in a basic environment.

In another aspect of the method, a material containing SiO₂ and/or Al₂O₃ is used which already comprises a basic alkali metal compound and/or alkaline earth metal compound or a source thereof. In this variant of the method, therefore, no basic alkali metal compound and/or alkaline earth metal compound or a source thereof is added, but, instead, the starting material used already comprises such a compound or a source thereof. This may be realized, for example, through use of a material containing SiO₂ and/or Al₂O₃ that comprises constituents or impurities which release a basic alkali metal compound and/or alkaline earth metal compound at the corresponding process temperature.

In a further variant of the method, additionally to SiO₂ and/or Al₂O₃, or material containing SiO₂ and/or Al₂O₃, as starting material, a basic alkali metal compound and/or alkaline earth metal compound or a source thereof is used from the start. With this variant, therefore, a starting material mixture is used which comprises not only SiO₂ and/or Al₂O₃, or material containing SiO₂ and/or Al₂O₃, but also a basic alkali metal compound and/or alkaline earth metal compound or a source thereof. In this case as well, the source of the basic alkali metal compound and/or alkaline earth metal compound then releases the basic alkali metal compound and/or alkaline earth metal compound at the corresponding process temperature.

A key advantage of the method is that it can be carried out as a cyclic process. In that case, the alkali metal silicates and/or alkaline earth metal silicates obtained as an end product are used again as a starting product, i.e., as material containing SiO₂ and/or Al₂O₃. Depending on whether the alkali metal silicates and/or aluminates and/or alkaline earth metal silicates and/or aluminates obtained still comprise a source of a basic alkali metal compound and/or alkaline earth metal compound, it is then no longer necessary to add a new basic alkali metal compound and/or alkaline earth metal compound or a corresponding source thereof. It is clear that this variant of the method has the advantage that the alkali metal silicate and/or aluminate material and/or alkaline earth metal silicate and/or aluminate material obtained in the production of ammonia can be used specifically again as a starting product, thereby allowing particularly effective utilization of the products used for the method. The required SiO₂ and/or Al₂O₃, or material containing SiO₂ and/or Al₂O₃, must therefore merely be supplemented. Therefore, ammonia is obtained from SiO₂ and/or Al₂O₃, or from material containing SiO₂ and/or Al₂O₃, in a cyclic process.

Oxides, hydroxides and/or carbonates are used with preference as basic alkali metal compound and/or alkaline earth metal compound. As a source of such a compound it is therefore preferred to use one that releases corresponding oxides, hydroxides and/or carbonates.

As already mentioned, both steps of the method use elevated temperatures, and it is necessary, accordingly, for thermal energy to be supplied. This may take place in a conventional way. In one particularly preferred variant of the method, however, the elevated temperature in the first and/or second method step is generated by microwave energy. This represents a particularly effective way of achieving the corresponding reaction temperatures to obtain the required reactive form of N₂ in the first step of the method, in particular by light arcs on the C center.

More particularly, the reaction to produce silicon nitride and/or aluminum nitride, or material containing silicon nitride and/or aluminum nitride, is carried out preferably at a temperature of 1100-2000° C., more preferably 1250-1500° C. The reaction to produce ammonia is carried out preferably at a temperature of 200-1000° C., preferably 400-800° C.

Reference has already been made above to the fact that, when the starting material for the thermal preparation of nitride already comprises one or more sources of basic alkali metal compounds and/or alkaline earth metal compounds, more particularly alkali/alkaline earth metal oxides, the nitride obtained is already enriched with basic material, and so it is possible to forego the further addition of basic material. Reaction with steam at elevated temperatures is then sufficient for the release of ammonia.

The product of the ammonia synthesis, i.e., the resultant alkali metal silicates and/or alkaline earth metal silicates, may, following addition of further carbon, be suitable directly again for formation of nitride, provided this product still comprises corresponding basic material. Further addition of basic material is superfluous in that event.

Starting materials containing silicon dioxide that are suitable for implementing the method include those which comprise aluminum, such as aluminosilicates and clay. Nitride preparation in that case results in silicon nitride with aluminum nitride as an impurity.

The silicon nitride obtained may also be present, for example, in the form of silicon oxynitride.

Starting materials used for the method preferably, in addition to SiO₂ in the form of sand, more particularly quartz sand, and Al₂O₃ (as bauxite), include minerals comprising alkali metal and/or alkaline earth metal silicates and/or aluminates, including aluminosilicates. These materials have the advantage that they can automatically provide the basic alkali metal compounds and/or alkaline earth metal compounds (oxides, hydroxides and the like) for the operation, without any need for these materials to be added subsequently. With regard to the starting materials used, therefore, it is possible, for example, to do without extensive purification measures, since materials of this kind containing silicate and/or aluminate are desired as starting material and it is not absolutely necessary to use pure SiO₂ or Al₂O₃.

In a further aspect of the method, the carbon source is obtained by pyrolysis of biomass.

It has emerged that through the pyrolysis of biomass it is possible for the carbon source required for the reduction of SiO₂ and/or Al₂O₃ to be provided in a simple and sufficient way, the pyrolysis process being controllable accordingly in such a way as to provide the required carbon source without the need to provide carbon from fossil sources additionally. The procedure is therefore to generate carbon in excess. Consumption of the resultant carbon by reaction, as, for example, a result of the supply of additional steam, is therefore preferably avoided, since a high yield of carbon is desired.

The biomass pyrolysis conducted produces hydrogen (H₂), carbon monoxide (CO), and more or less pure carbon in the form of charcoal, carbonized material and the like. The latter substances may be purified (activated) accordingly and are then used in the subsequent first step of the method for producing ammonia to reduce SiO₂/Al₂O₃ or material containing SiO₂/Al₂O₃.

The pyrolysis of the biomass is carried out preferably at temperatures ≧800° C. The corresponding method corresponds, similarly to the conventional gasification of coal, to the preparation of synthesis gas, the end products obtained comprising synthesis gas (H₂, CO) and a corresponding carbon source. Since the biomass used generally contains different concentrations of water, in part in the form of free liquid, in some cases alternatively bound in organic molecules, as in the form of cellulose, for example, the biomass is preferably dried before the pyrolysis.

In the production of synthesis gas it is usual to heat dried biomass with accompanying supply of additional steam to consume the resultant carbon by reaction. The pyrolysis is carried out preferably without addition of steam to obtain a sufficient amount (excess) of the carbon source required for the subsequent method for producing ammonia.

The synthesis gas (H₂, CO) obtained in the pyrolysis is usefully burned to produce thermal energy which is used to generate the elevated temperatures in the first and/or second step of the method. The CO₂ which is formed in this process may be collected and used, for example, for the further processing of the ammonia produced.

The method therefore has a favorable energy balance since some of the required energy (for the pyrolysis of the biomass and for the first and second steps of the method) can be provided by the combustion of the synthesis gas obtained in the pyrolysis.

The carbon source obtained by the pyrolysis of biomass may be added to the alkali metal silicates/aluminates and/or alkaline earth metal silicates/aluminates obtained in the production of ammonia to generate nitride therefrom. This procedure is carried out when the resultant alkali metal silicates/aluminates and/or alkaline earth metal silicates/aluminates still comprise corresponding basic material.

### EXAMPLE

Quartz sand was reacted with addition of carbon and gaseous nitrogen at a temperature of 1300° C. to produce silicon nitride. Following addition of Na₂CO₃, the silicon nitride obtained was reacted with steam at 800° C. to produce ammonia. An 85% yield of NH₃ was achieved in this operation.

1. A method for producing ammonia comprising:
reacting SiO₂ and/or Al₂O₃, or material containing SiO₂ and/or Al₂O₃, with addition of a carbon source, with gaseous nitrogen at elevated temperature to produce silicon nitride (Si₃N₄) and/or aluminum nitride (AlN), or material containing silicon nitride and/or aluminum nitride, and
reacting resultant silicon nitride and/or aluminum nitride, or material containing silicon nitride and/or aluminum nitride, in the presence of a basic alkali metal compound and/or alkaline earth metal compound, with water at elevated temperature to produce ammonia and alkali metal silicates and/or alkaline earth metal silicates.

2. The method according to claim 1, wherein the basic alkali metal compound and/or alkaline earth metal compound or a source thereof is added to the silicon nitride and/or aluminum nitride, or material containing silicon nitride and/or aluminum nitride, before addition of water.

3. The method according to claim 1, wherein a material containing SiO₂ and/or Al₂O₃ is used which already comprises a basic alkali metal compound and/or alkaline earth metal compound or a source thereof.

4. The method according to claim 1, wherein, in addition to SiO₂ and/or Al₂O₃, or material containing SiO₂ and/or Al₂O₃, as starting material, a basic alkali metal compound and/or alkaline earth metal compound or a source thereof is used.

5. The method according to claim 1, wherein a basic alkali metal compound and/or alkaline earth metal compound is released from a corresponding source under the process conditions.

6. The method according to claim 1, carried out as a cyclic process and resultant alkali metal silicates and/or alkaline earth metal silicates are used again as starting material containing SiO₂ and/or Al₂O₃.

7. The method according to claim 1, wherein oxides, hydroxides and/or carbonates are used or generated as basic alkali metal compound and/or alkaline earth metal compound.

8. The method according to claim 1, wherein the reaction that produces silicon nitride and/or aluminum nitride, or material containing silicon nitride and/or aluminum nitride, is carried out at a temperature of 1100-2000° C.

9. The method according to claim 1, wherein the reaction that produces ammonia from silicon nitride and/or aluminum nitride, or material containing silicon nitride and/or aluminum nitride, is carried out at a temperature of 200-1000° C.

10. The method according to claim 1, wherein the elevated temperature in the first and/or second method step is generated by microwave energy.

11. The method according to claim 1, wherein the carbon source is obtained by pyrolysis of biomass.

12. The method according to claim 11, wherein pyrolysis is carried out at temperatures 800° C.

13. The method according to claim 11, wherein the biomass is dried before the pyrolysis.

14. The method according to claim 11, wherein the pyrolysis is carried out without addition of steam.

15. The method according to claim 11, wherein synthesis gas (H₂, CO) obtained in the pyrolysis is burned to obtain thermal energy which is used to generate the elevated temperatures in a first and/or second method step.

16. The method according to claim 11, wherein the carbon source obtained by the pyrolysis of biomass is added to the alkali metal silicates/aluminates and/or alkaline earth metal silicates/aluminates obtained in the ammonia production, for the production of nitride therefrom.

17. The method according to claim 12, wherein the biomass is dried before the pyrolysis.

18. The method according to claim 12, wherein the pyrolysis is carried out without addition of steam.

19. The method according to claim 13, wherein the pyrolysis is carried out without addition of steam.

20. The method according to claim 12, wherein synthesis gas (H₂, CO) obtained in the pyrolysis is burned to obtain thermal energy which is used to generate the elevated temperatures in a first and/or second method step.
